(19) United States
(12) Patent Application Publication
(10) Pub. No.: US 2007/0036049 A1
(43) Pub. Date: Feb. 15, 2007

(54) Dual-deck optical disc system and method of controlling the same

(75) Inventors: Gi Soo Im, Suwon-Si (KR); Jun Ho Song, Suwon-Si (KR); Deuk Hoon Lee, Suwon-Si (KR); Joung Hoon Kim, Suwon-Si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/498,132

(22) Filed: Aug. 3, 2006

(30) Foreign Application Priority Data
Aug. 10, 2005 (KR) 2005-73468

(51) Int. Cl. G11B 20/00

(52) U.S. Cl. 369/47.16

(57) ABSTRACT

A dual-deck optical disc system and a method of controlling the dual-deck optical disc system enable data to be simultaneously recorded and reproduced. The dual-deck optical disc system may include a plurality of decks operable to record data on and reproduce data from optical discs mounted in the plurality of decks; and a controller that controls the plurality of decks to record an external signal on a first optical disc of the optical discs while reproducing data from a second optical disc of the optical discs.

### CROSS-REFERENCE TO RELATED APPLICATION

This application claims the benefit of Korean Patent Application No. 2005-73468 filed on Aug. 10, 2005, in the Korean Intellectual Property Office, the disclosure of which is incorporated herein by reference.

### BACKGROUND OF THE INVENTION

1. Field of the Invention

An aspect of the invention relates to a dual-deck optical disc system including a recording deck and a reproducing deck, and more particularly to a dual-deck optical disc system that can simultaneously record and reproduce data, and a method of controlling the dual-deck optical disc system.

2. Description of the Related Art

As video and audio signal processing technologies have been developed, recording media, such as an optical disc, for example, a DVD, etc., have been developed and are being sold on the market. These recording media can record high quality video data and high quality audio data and have a long recording time. Also, optical disc systems, for example, a DVD recorder, etc., have been developed and are being sold on the market. An optical disc system records video and/or audio data on an optical disc, and plays back video and/or audio data from an optical disc.

More specifically, the optical disc system plays back video data and/or audio data recorded on an optical disc to output video to be displayed on a screen and/or audio to be reproduced through a speaker. Namely, the optical disc system serves to play back and output information recorded on an optical disc, and also to record broadcasting signals transmitted from broadcast stations, or external signals, such as TV signals inputted from a television set, on an optical disc.

A conventional single-deck optical disc system includes a single deck that plays back information recorded on an optical disc inserted in the single deck by reproducing information recorded on the optical disc and outputting the reproduced information to a display device, such as a television set.

Also, the conventional single-deck optical disc system records external input signals received by a tuner, such as a TV broadcasting signal, etc., on an optical disc inserted in the single deck.

However, since the conventional single-deck optical disc system reproduces information recorded on an optical disc and records external input signals, such as a TV broadcasting signal, on an optical disc using a single deck, it has a drawback in that, when the system records a TV program on a rewritable optical disc after reproducing a movie recorded in a recordable optical disc, the recordable optical disc must be removed from the single deck, and then the rewritable optical disc must be inserted to record the TV program. Also, the conventional single-deck optical disc system has a drawback in that users cannot play a movie while recording a TV program or other external signal.

### SUMMARY OF THE INVENTION

In accordance with an aspect of the invention, there is provided a dual-deck optical disc system including a recording deck and a reproducing deck that can simultaneously perform a recording operation and a reproducing operation, and a method of controlling the dual-deck optical disc system.

In accordance with another aspect of the invention, there is provided a dual-deck optical disc system that can directly copy data of one optical disc mounted in a reproducing deck onto another optical disc mounted in a recording deck while simultaneously allowing a user to watch video and listen to audio of an external signal received by the dual-deck optical system on a TV, and a method of controlling the dual-deck optical disc system.

In accordance with another aspect of the invention there is provided a dual-deck optical disc system that can display messages notifying a user of completion of a recording operation and errors in a recording operation on a TV screen while simultaneously performing a reproducing operation and displaying reproduced data obtained during the reproducing operation on the TV screen, and a method of controlling the dual-deck optical disc system.

In accordance with an another aspect of the invention, a dual-deck optical disc system includes a plurality of decks operable to record data on and reproduce data from optical discs mounted in the plurality of decks; and a controller that controls the plurality of decks to record an external signal on a first optical disc while reproducing data from a second optical disc of the optical discs.

The plurality of decks may include a first deck operable to record data on and reproduce data from the first optical disc, and a second deck operable only to reproduce data from the second optical disc. The controller may control the first deck to record data on and reproduce data from the first optical disc, and independently control the second deck to reproduce data from the second optical deck.

The dual-deck optical disc system may further include an input unit operable by a user to input a command to simultaneously record and reproduce data. The controller, in response to the command to simultaneously record and reproduce data, may control a first deck of the plurality of decks to record the external signal on the first optical disc, and simultaneously control a second deck of the plurality of decks to reproduce data from the second optical disc.

The dual-deck optical disc system may further include a tuner that receives the external signal. The controller, in response to the command to simultaneously record and reproduce data, may transmit the external signal received by the tuner to the first deck which then records the external signal on the first deck.

In accordance with another aspect of the invention, a dual-deck optical disc system includes a plurality of decks operable to record data on and reproduce data from optical discs mounted in the plurality of decks; and a controller that outputs an external signal to a display device while controlling the plurality of decks to perform a copy operation using optical the discs.

The plurality of decks may include a first deck operable to record data on and reproduce data from a first optical disc of the optical discs, and a second deck operable only to reproduce data from a second optical disc of the optical discs. The controller, during the copy operation, may transmit data reproduced from the second optical disc by the second deck to the first deck when then copies the reproduced data onto the first optical disc, thereby performing the copy operation.

The dual-deck optical disc system may further include an input unit operable by a user to input a command to simultaneously perform the copy operation and output the external signal to the display device. The controller, in response to the command to simultaneously perform the copy operation and output the external signal to the display device, may control a first deck of the plurality of decks having mounted therein a first optical disc of the optical discs and a second deck of the plurality of decks having mounted therein a second optical disc of the optical discs to perform the copy operation by copying data of the second optical disc mounted in the second deck onto the first optical disc mounted in the first deck, and simultaneously output the external signal to the display screen.

The dual-deck optical disc system may further include a tuner that receives the external signal. The controller, in response to the command to simultaneously perform the copy operation and output the external signal to the display device, may transmit the external signal received by the tuner to the display device.

In accordance with another aspect of the invention, there is provided a method of controlling a dual-deck optical disc system, the dual-deck optical deck system including a plurality of decks operable to record data on and reproduce data from optical discs mounted in the plurality of decks, the method including receiving from a user a command to simultaneously record and reproduce data; and in response to the command to simultaneously record and reproduce data, controlling a first deck of the plurality of decks having mounted therein a first optical disc of the optical discs and a second deck of the plurality of decks having mounted therein a second optical disc of the optical discs so that first deck records an external signal on the first optical disc mounted in the first deck while the second deck simultaneously reproduces data from the second optical disc mounted in the second deck.

The method may further include displaying the data being reproduced from the second optical disc on a display device while the external signal is being recorded on the first optical disc; determining whether an error has occurred in the first deck that is recording the external signal on the first optical disc and whether the first deck has completed the recording of the external signal on the first optical while the second deck is simultaneously reproducing data from the second optical disc; and displaying a message on the display device on which the data being reproduced from the other optical disc is being displayed to notify the user when an error has occurred in the first deck that is recording the external signal on the first optical disc or when the first deck has completed the recording of the external signal on the first optical disc.

The method may further include displaying the data being reproduced from the second optical disc on a display device while the external signal is being recorded on the first optical disc; and displaying the external signal being recorded on the first optical disc in a picture-in-picture (PIP) window on the display device while the data being reproduced from the second optical disc is being displayed on the display device.

In accordance with another aspect of the invention, there is provided a method of controlling a dual-deck optical disc system, the dual-deck optical disc system including a plurality of decks operable to record data on and reproduce data from optical discs mounted in the plurality of decks, the method including receiving from a user a command to simultaneously perform a copy operation and output an external signal to a display device; and in response to the command to simultaneously perform a copy operation and output an external signal to a display device, controlling a first deck the plurality of decks having mounted therein a first optical disc of the optical discs and a second deck of the plurality of decks having mounted therein a second optical disc of the plurality of optical discs to perform the copy operation by copying data of the second optical disc mounted in the second deck onto the first optical disc mounted in the first deck, and simultaneously outputting the external signal to the display device.

The method may further include displaying the external signal on the display device while the first deck and the second deck are performing the copy operation; determining whether an error has occurred in the copy operation and whether copy operation has been completed while the external signal is being simultaneously output to and displayed on the display device; and displaying a message on the display device on which the external signal is being displayed to notify the user when an error has occurred in the copy operation or when the copy operation has been completed.

Additional aspects and/or advantages of the invention will be set forth in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of various embodiments, taken in conjunction with the accompanying drawings of which:

FIG. 1 is a schematic block diagram of a dual-deck optical disc system according to an aspect of the invention;

FIG. 2 is a flow chart of a method of simultaneously recording and reproducing data in a dual-deck optical disc system according to an aspect of the invention; and

FIG. 3 is a flow chart of a method of simultaneously performing a copy operation and outputting an external signal to a display device in a dual-deck optical disc system according to an aspect of the invention.

### DETAILED DESCRIPTION OF THE EMBODIMENTS

Reference will now be made in detail to various embodiments of the invention, examples of which are shown in the accompanying drawings, wherein like reference numerals refer to the elements throughout. The embodiments are described below in order to explain the invention by referring to the figures.

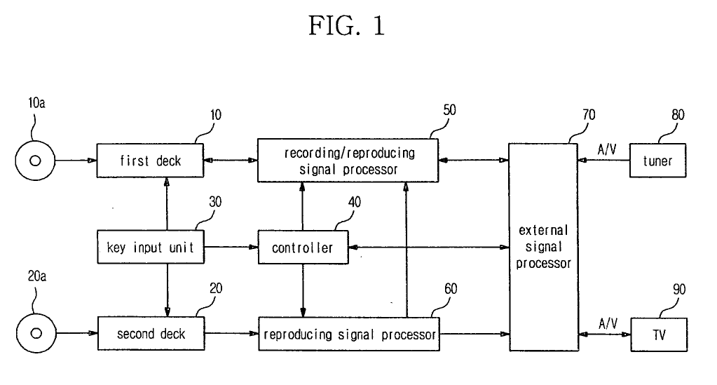

FIG. 1 is a schematic block diagram of a dual-deck optical disc system according to an aspect of the invention. The dual-deck optical disc system includes a first recording/reproducing deck 10 for recording/reproducing an optical disc 10a, a second reproducing-only deck 20 for reproducing an optical disc 20a, a key input unit 30, a controller 40, a recording/reproducing signal processor 50, a reproducing signal processor 60, an external signal processor 70, a tuner 80, and a TV 90. The first recording/reproducing deck 10 and the second reproducing-only deck 20 are installed as a set of decks in a single dual-deck optical disc system. Although element 90 is described as a TV, it may be any type of display device capable of displaying a video signal and outputting an audio signal.

The optical disc 10a recorded and reproduced by the first recording/reproducing deck 10 may be a rewritable optical disc such as a DVD-Rewritable (DVD-RW), a DVD-Random Access Memory (DVD-RAM), a CD-Rewritable (CD-RW), etc., or a recordable optical disc such as a DVD-Recordable (DVD-R), a CD-Recordable (CD-R), etc.

The optical disc 20a reproduced by the second reproducing-only deck 20 may be a reproducible optical disc such as a DVD-R, a DVD-RW, a DVD-RAM, a CD-R, a CD-RW, etc.

The optical discs 10a and 20a may have various formats, such as a Video (V) mode and a Video Recording (VR) mode.

The first recording/reproducing deck 10 includes an optical pick-up and an optical pick-up driver that drives the optical pick-up to emit a laser beam to record data on and reproduce data from the optical disc 10a. The second reproducing-only deck 20 includes an optical pick-up and an optical pick-up driver that drives the optical pickup to emit a laser beam to reproduce data from the optical disc 20a. These optical pick-ups and optical pick-up drivers are not shown in FIG. 1.

The key input unit 30 enables a user to input commands to control operations of the first deck 10 and the second deck 20. The key input unit 30 includes a key that enables a user to input a command to simultaneously record and reproduce data to control the first deck 10 to record an external input signal on the optical disc 10a, and to simultaneously control the second deck 20 to reproduce data from the optical disc 20a, and a plurality of keys that enable a user to input a command to simultaneously perform a copy operation and display an external input signal to control the first deck 10 and the second deck 20 to copy all or part of data of the optical disc 20a mounted in the second deck 20 onto the optical disc 10a mounted in the first deck 10, and to simultaneously display an external input signal on the TV 90.

The controller 40 controls the dual-deck optical disc system according to the commands inputted through the key input unit 30 by the user. More specifically, the controller 40 controls a recording operation and a reproducing operation of the first deck 10, a reproducing operation of the second deck 20, a copy operation in which all or part of data of the optical disc 20a mounted in the second deck 20 is copied onto the optical disc 10a mounted in the first deck 10, a recording operation of the first deck 10 to record an external input signal, and an outputting operation in which an external input signal is outputted to the TV 90.

The recording/reproducing signal processor 50 performs a reproducing signal processing operation in which MPEG data reproduced from the optical disc 10a by the first deck 10 is decoded to obtain decoded data, and the decoded data is transmitted to the external signal processor 70. Also, the recording/reproducing signal processor 50 performs a recording signal processing operation in which uncoded data transmitted from the external signal processor 70 is encoded to obtain MPEG data, and the MPEG data is recorded on the optical disc 10a by the first deck 10. In addition, the recording/reproducing signal processor 50 performs a copy signal processing operation in which decoded data transmitted from the reproducing signal processor 60 is encoded to obtain MPEG data, and the MPEG data is transmitted to the first deck 10 where it is copied onto the optical disc 10a. In addition to or in place of the copy signal processing operation, the recording/reproducing signal processor 50 may perform a high-speed copy signal processing operation in which undecoded MPEG data transmitted directly to the recording/reproducing signal processor 50 from the reproducing signal processor 60 is transmitted by the recording/reproducing signal processor 50 directly to the first deck 10 where it is directly copied onto the optical disc 10a without having been decoded in the reproducing signal processor 60 and encoded in the recording/reproducing signal processor 50.

The reproducing signal processor 60 performs a reproducing signal processing operation in which MPEG data reproduced from the optical disc 20a by the second deck 20 is decoded to obtain decoded data, and the decoded data is transmitted to the external signal processor 70. Also, the reproducing signal processor 60 performs a copy signal processing operation in which MPEG data reproduced from the optical disc 20a by the second deck 20 is decoded to obtain decoded data, and the decoded data is transmitted to the recording/reproducing signal processor 50 which encodes the decoded data to obtain MPEG data, and transmits the MPEG data to the first deck to be copied onto the optical disc 10a by the first deck 10. In addition to or in place of the copy signal processing operation, the reproducing signal processor 60 may perform a high-speed copy signal processing operation in which MPEG data reproduced from the optical disc 20a by the second deck 20 is transmitted to the recording/reproducing signal processor 60 which transmits the MPEG data directly to the first deck 10 where it is directly copied onto the optical disc 10a without having been decoded in the reproducing signal processor 60 and encoded in the recording/reproducing signal processor 50.

The external signal processor 70 receives an external input signal, such as a TV input signal, an A/V (audio/video) input signal, or a DV (digital video) input signal, etc., received by the tuner 80, processes the external input signal to obtain video and audio signals, and transmits the video and audio signals to the TV 90 or the recording/reproducing signal processor 50. Also, the external signal processor 70 processes video and audio signals transmitted from the recording/reproducing signal processor 50 or the reproducing signal processor 60 that were decoded from reproduced MPEG data in the recording/reproducing signal processor 50 or the reproducing signal processor 60, and transmits the processed video and audio signals to the TV 90, thereby enabling reproduced data to be output to the outside.

Also, the external signal processor 70 includes an audio/video A/D converter that converts an analog audio/video signal to digital data, an IEEE 1394 processor that processes a DV input signal to obtain digital data, and an A/V signal processor that processes digital data and outputs an analog and/or digital audio/video signal to the TV 90. These elements are well known in the art, and accordingly detailed descriptions of these elements will not be provided.

A method of controlling a dual-deck optical disc system according to an aspect of the invention will now be described.

The dual-deck optical disc system of the present invention is configured so that a first deck 10 which is a recording/reproducing deck and a second deck 20 which is a recording-only deck are installed as a set of decks in a single dual-deck optical disc system, thereby making it possible to simultaneously perform a recording operation and a reproducing operation.

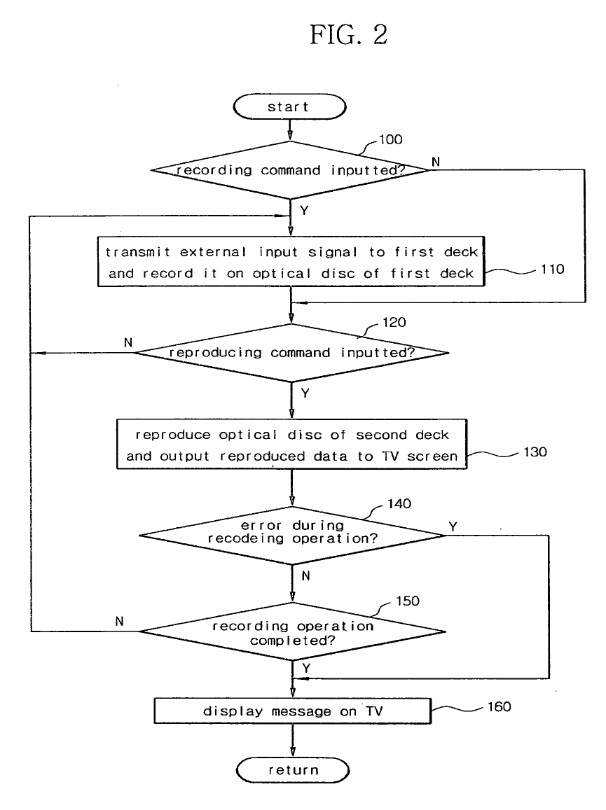

FIG. 2 is a flow chart of a method of simultaneously recording and reproducing data in a dual-deck optical disc system according to an aspect of the invention.

First, a recordable optical disc 10a is mounted in the first deck 10, and a reproducible optical disc 20a is mounted in the second deck 20, and the controller 40 obtains basic information about the optical discs 10a and 20a mounted in the first deck 10 and the second deck 20.

Next, the controller 40 determines whether a recording command has been inputted through the key input unit 30 (block 100). When the controller 40 determines that a recording command has been inputted, an external input signal such as a TV input signal, an A/V input signal, a DV input signal, etc., is transmitted to the first deck 10 which records the external input signal on the optical disc 10a (block 110).

If the external input signal is an analog audio/video signal inputted to the external signal processor 70 through the tuner 80, the analog audio/video signal is converted to digital data by the audio/video A/D converter of the external signal processor 70 referred to above, and the digital data is transmitted to the recording/reproducing signal processor 50. The recording/reproducing signal processor 50 encodes the digital data to obtain MPEG2 data, and transmits the MPEG2 data to the first deck 10 through an Advanced Technology Attachment Packet Interface (ATAPI) so that the MPEG2 data obtained by processing the external input signal is recorded on the optical disc 10a by the first deck 10.

If the external input signal is a DV input signal, the DV input signal is processed by the IEEE 1394 processor of the external signal processor 70 referred to above to obtain digital data, and the digital data is transmitted to the recording/reproducing signal processor 50.

The controller 40 also determines whether a reproducing command has been inputted through the key input unit 30, regardless of whether or not the above-described recording operation is being performed (block 120). When the controller 40 determines that a reproducing command has been inputted, the optical deck 20 reproduces data from the optical disc 20a and the reproduced data is transmitted to the TV 90 (block 130).

The data that is reproduced from the optical disc 20a by the second deck 20 is decoded by the reproducing signal processor 60 which transmits the decoded data to the external signal processor 70 where the A/V signal processor of the external signal processor 70 referred to above processes the decoded data and outputs an analog and/or digital audio/video signal to the TV 90.

While the recording operation and the reproducing operation are being simultaneously performed by the first deck 10 and the second deck 20, the controller 40 determines whether an error has occurred in the recording operation being performed by the first deck 10 (block 140), and whether the recording operation has been completed (block 150).

When the controller 40 determines that an error has occurred in the recording operation or that the recording operation has been completed, the controller 40 controls the external signal processor 70 to display a message on the TV 90 to notify a user that an error has occurred in the recording operation or that the recording has been completed while the TV 90 is displaying the data being reproduced during the reproducing operation (block 160). This enables the user to monitor the state of the recording operation to determine whether to continue or stop the recording operation while the user is watching the data being reproduced during the reproducing operation on the TV 90.

A dual-deck optical disc system according to an aspect of the invention may include an additional function of displaying the external input signal being recorded on the optical disc 10a and/or the message to the user in a picture-in-picture (PIP) window on the TV 90 while data being reproduced from the optical disc 20a is being displayed on the TV 90. Alternatively, the data being reproduced from the optical disc 20a may be displayed in the PIP window on the TV 90 while the external signal being recorded on the optical disc 10a and/or the message to the user is displayed on the TV 90.

A dual-deck optical disc system according to an aspect of the invention may also copy data of the optical disc 20a onto the optical disc 10a while simultaneously displaying an external input signal on the TV 90.

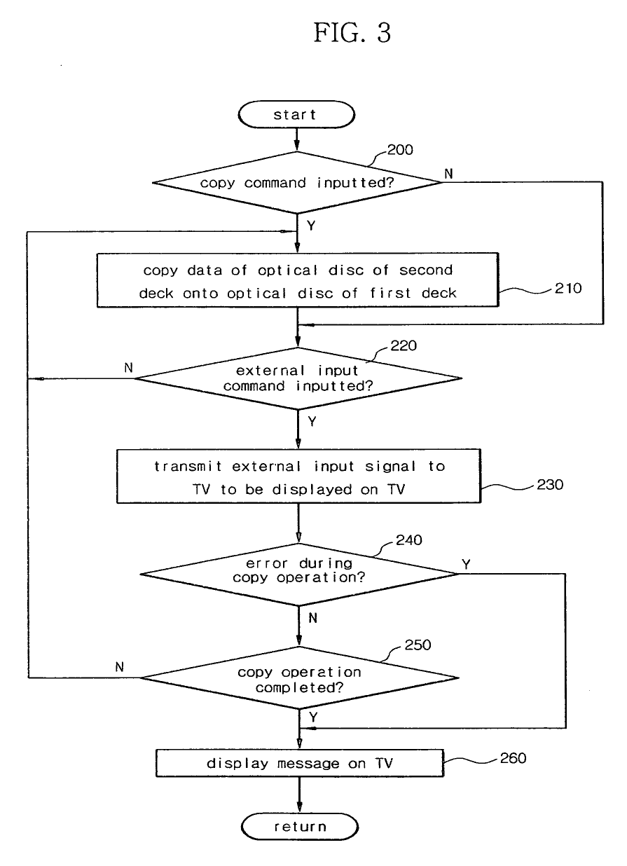

FIG. 3 is a flow chart of a method of simultaneously copying data of the optical disc 20a onto the optical disc 10 while simultaneously displaying an external signal on the TV 90 in a dual-deck optical disc system according to an aspect of the invention.

First, a recordable optical disc 10a is mounted in the first deck 10, and a reproducible optical disc 20a is mounted in the second deck 20, and the controller 40 obtains basic information about the optical discs 10a and 20a mounted in the first deck 10 and the second deck 20.

Next, the controller 40 determines whether a copy command has been inputted through the key input unit 30 (block 200). When the controller 40 determines that a copy command has been inputted, all or part of data of the optical disc 20a is reproduced by the second deck 20 and the reproduced data is copied onto the optical disc 10a by the first deck 10 (block 210).

The controller 40 controls the reproducing signal processor 60 to decode MPEG2 data reproduced from the optical disc 20a by the second deck 20 to obtain decoded data, and transmit the decoded data to the recording/reproducing signal processor 50, and simultaneously controls the recording/reproducing signal processor 50 to encode the decoded data transmitted from the reproducing signal processor 60 to obtain MPEG2 data, and transmit the MPEG2 data to the first deck 10 through an Advanced Technology Attachment Packet Interface (ATAPI) to be copied onto the optical disc 10a by the first deck 10. This copy operation is a normal-speed copy operation that requires substantially the same amount of time as is required to reproduce data being copied at a normal speed at which the data being copied is intended to be viewed and/or listened to.

Alternatively, the controller 40 may control the reproducing signal processor 60 and the recording/reproducing signal processor 60 to perform a high-speed copy operation that requires substantially less time than is required to reproduce data being copied at a normal speed at which the data being copied is intended to be viewed or listened to, for example half as much time or less. In the high-speed copy operation, the controller 40 controls the reproducing signal processor 60 to transmit MPEG 2 data reproduced from the optical disc 20a by the second deck 20 directly to the recording/reproducing signal processor 50, and simultaneously controls the recording/reproducing signal processor 50 to transmit the MPEG2 data transmitted from the reproducing signal processor 60 directly to the first deck 10 to be copied onto the optical disc 10a by the first deck 10. In the high-speed copy operation, the reproducing signal processor 60 only transmits the MPEG2 data reproduced from the optical disc 20a to the recording/reproducing signal processor 50. It does not perform an MPEG2 decoding operation as it does in the normal-speed copy operation described above. Also, the recording/reproducing signal processor 50 only transmits the MPEG2 data received from the reproducing signal processor 60 to the first deck 10 to be directly recorded on the optical disc 10a. It does not perform an MPEG2 encoding operation as it does in the normal-speed copy operation described above. The MPEG2 data reproduced from the optical disc 20a by the second deck 20 can be directly copied onto the optical disc 10a by the first deck 10 since more than two ATAPI standards are supported.

The controller 40 also determines whether an external input command has been inputted through the key input unit 30, regardless of whether the above-described copy operation is being performed (block 220). When the controller 40 determines that an external input command has been inputted, the controller 40 controls the external signal processor 70 to transmit an external input signal, such as a TV input signal, an A/V input signal, a DV input signal, etc., received by the tuner 80 to the TV 90 to be displayed (block 230).

While the copy operation and the operation of transmitting the external input signal to the TV 90 are being simultaneously performed, the controller 40 determines whether an error has occurred during the copy operation (block 240) or whether the copy operation has been completed (block 250).

When the controller 40 determines that an error has occurred during the copy operation or that the copy operation has been completed, the controller 40 controls the external signal processor 70 to display a message on the TV 90 to notify a user that an error has occurred in the copy operation or that the copy operation has been completed while the TV 90 is displaying the external signal (block 260). This enables the user to monitor the state of the copy operation to determine whether to continue or stop the copy operation while the user is watching the external input signal on the TV 90.

It will be easily appreciated that instead of displaying the external input signal on the TV 90, a dual-deck optical disc system according to an aspect of the invention may display the data being reproduced from the optical disc 10a during the copy operation on the TV 90 according to a command inputted through the key input unit 30.

A dual-deck optical disc system according to an aspect of the invention may include an additional function of displaying data being reproduced from the optical disc 20a during the copy operation and/or the message to the user in a picture-in-picture (PIP) window on the TV 90 while the external input signal is being displayed on the TV 90. Alternatively, the external input signal may be displayed in the PIP window on the TV 90 while the data being reproduced from the optical disc 20a during the copy operation and/or the message to the user is displayed on the TV 90.

As described above, a dual-deck optical disc system and a method of controlling the same according to an aspect of the invention can simultaneously perform a recording operation and a reproducing operation in which a recording deck records an external input signal on a recordable optical disc while a reproducing deck simultaneously reproduces data from an optical disc.

Also, a dual-deck optical disc system and a method of controlling the same according to an aspect of the invention can directly copy data of an optical disc mounted in a reproducing deck onto an optical disc mounted in a recording deck while simultaneously allowing a user to watch an external input signal on a TV or other display device.

In addition, a dual-deck optical disc system and a method of controlling the same according to an aspect of the invention can display a message on a TV or other display device to notify a user if an error has occurred in a recording operation or if a recording operation has been completed while the TV or other display device is displaying an external input signal or data reproduced during a reproducing operation.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A dual-deck optical disc system comprising:
a plurality of decks operable to record data on and reproduce data from optical discs mounted in the plurality of decks; and
a controller that controls the plurality of decks to record an external signal on a first optical disc of the optical discs while reproducing data from a second optical disc of the optical discs.

2. The dual-deck optical disc system of claim 1, wherein the plurality of decks comprise a first deck operable to record data on and reproduce data from the first optical disc, and a second deck operable only to reproduce data from the second optical disc;
wherein the controller controls the first deck to record data on and reproduce data from the first optical disc, and independently controls the second deck to reproduce data from the second optical disc.

3. The dual-deck optical disc system of claim 1, further comprising an input unit operable by a user to input a command to simultaneously record and reproduce data;
wherein the controller, in response to the command to simultaneously record and reproduce data, controls a first deck of the plurality of decks to record the external signal on the first optical disc, and simultaneously controls a second deck of the plurality of decks to reproduce data from the second optical disc.

4. The dual-deck optical disc system of claim 3, further comprising a tuner that receives the external signal;
wherein the controller, in response to the command to simultaneously record and reproduce data, transmits the external signal received by the tuner to the first deck which then records the external signal on the first optical disc.

5. The dual-deck optical deck system of claim 4, further comprising:
a recording/reproducing signal processor;
a reproducing signal processor; and
an external signal processor;
wherein the controller, in response to the command to simultaneously record and reproduce data,
controls the external signal processor to receive the external signal from the tuner, process the external signal to obtain processed data, and transmit the processed data to the recording/reproducing signal processor,
controls the recording/reproducing signal processor to receive the processed data from the external signal processor, encode the processed data to obtain encoded data, and transmit the encoded data to the first deck which then records the encoded data on the first optical disc,
controls the reproducing signal processor to receive the data reproduced from the second optical disc by the second deck, decode the reproduced data to obtain decoded data, and transmit the decoded data to the external signal processor, and
controls the external signal processor to receive the decoded data from the reproducing signal processor, process the decoded data to obtain video and audio signals, and transmit the video and audio signals to a display device.

6. The dual-deck optical system of claim 1, wherein the external signal is a TV input signal, an A/V (audio/video) input signal, or a DV (digital video) input signal.

7. A dual-deck optical disc system comprising:
a plurality of decks operable to record data on and reproduce data from optical discs mounted in the plurality of decks; and
a controller that outputs an external signal to a display device while controlling the plurality of decks to perform a copy operation using the optical discs.

8. The dual-deck optical disc system of claim 7, wherein the plurality of decks comprise a first deck operable to record data on and reproduce data from a first optical disc of the optical discs, and a second deck operable only to reproduce data from a second optical disc of the optical discs; and
wherein the controller, during the copy operation, transmits data reproduced from the second optical disc by the second deck to the first deck which then copies the reproduced data onto the first optical disc, thereby performing the copy operation.

9. The dual-deck optical disc system of claim 7, further comprising an input unit operable by a user to input a command to simultaneously perform the copy operation and output the external signal to the display device;
wherein the controller, in response to the command to simultaneously perform the copy operation and output the external signal to the display device, controls a first deck of the plurality of decks having mounted therein a first optical disc of the optical discs and a second deck of the plurality of decks having mounted therein a second optical disc of the optical discs to perform the copy operation by copying data of the second optical disc mounted in the second deck onto the first optical disc mounted in the first deck, and simultaneously outputs the external signal to the display device.

10. The dual-deck optical disc system of claim 9, further comprising a tuner that receives the external signal;
wherein the controller, in response to the command to simultaneously perform the copy operation and output the external signal to the display device, transmits the external signal received by the tuner to the display device.

11. The dual-deck optical deck system of claim 10, further comprising:
a recording/reproducing signal processor;
a reproducing signal processor; and
an external signal processor;
wherein the copy operation is a normal-speed copy operation that requires substantially a same amount of time as is required to reproduce data being copied at a normal speed at which the data being copied is intended to be viewed and/or listened to; and
wherein the controller, in response to the command to simultaneously perform the copy operation and output the external signal to the display device,
controls the reproducing signal processor to receive data reproduced from the second optical disc by the second deck, decode the reproduced data to obtain decoded data, and transmit the decoded data to the recording/reproducing signal processor;
controls the recording/reproducing signal processor to receive the decoded data from the reproducing signal processor, encode the decoded data to obtain encoded data, and transmit the encoded data to the first one deck which then copies the encoded data onto the first optical disc; and
controls the external signal processor to receive the external signal from the tuner, process the external signal to obtain video and audio signals, and transmit the video and audio signals to the display device.

12. The dual-deck optical deck system of claim 10, further comprising:
a recording/reproducing signal processor;
a reproducing signal processor; and
an external signal processor;
wherein the copy operation is a high-speed copy operation that requires no more than half as much time as is required to reproduce data being copied at a normal speed at which the data being copied is intended to be viewed and/or listened to; and
wherein the controller, in response to the command to simultaneously perform the copy operation and output the external signal to the display device,
controls the reproducing signal processor to receive data reproduced from the second optical disc by the second deck and, without decoding the reproduced data, transmit the reproduced data to the recording/reproducing signal processor;
controls the recording/reproducing signal processor to receive the reproduced data from the reproducing signal processor and, without encoding the reproduced data, transmit the reproduced data to the first deck which then copies the reproduced data onto the first optical disc; and
controls the external signal processor to receive the external signal from the tuner, process the external signal to obtain video and audio signals, and transmit the video and audio signals to the display device.

13. The dual-deck optical system of claim 7, wherein the external signal is a TV input signal, an A/V (audio/video) input signal, or a DV (digital video) input signal.

14. A method of controlling a dual-deck optical disc system, the dual-deck optical deck system comprising a plurality of decks operable to record data on and reproduce data from optical discs mounted in the plurality of decks, the method comprising:
receiving from a user a command to simultaneously record and reproduce data; and
in response to the command to simultaneously record and reproduce data, controlling a first deck of the plurality of decks having mounted therein a first optical disc of the optical discs and a second deck of the plurality of decks having mounted therein a second optical disc of the optical discs so that the first deck records an external signal on the first optical disc mounted in the first deck while the second deck simultaneously reproduces data from the second optical disc mounted in the second deck.

15. The method of claim 14, further comprising:
displaying the data being reproduced from the second optical disc on a display device while the external signal is being recorded on the first optical disc;
determining whether an error has occurred in the first deck that is recording the external signal on the first optical disc and whether the first deck has completed the recording of the external signal on the first optical disc while the second deck is simultaneously reproducing data from the second optical disc; and
displaying a message on the display device on which the data being reproduced from the second optical disc is being displayed to notify the user when an error has occurred in the first deck that is recording the external signal on the first optical disc or when the first deck has completed the recording of the external signal on the first optical disc.

16. The method of claim 14, further comprising:
displaying the data being reproduced from the second optical disc on a display device while the external signal is being recorded on the first optical disc; and
displaying the external signal being recorded on the first optical disc in a picture-in-picture (PIP) window on the display device while the data being reproduced from the second optical disc is being displayed on the display device.

17. The method of claim 14, wherein the dual-deck optical disc system further comprises
a recording/reproducing signal processor;
a reproducing signal processor; and
an external signal processor; and
wherein the method further comprises, in response to the command to simultaneously record and reproduce data:
controlling the external signal processor to receive the external signal, process the external signal to obtain processed data, and transmit the processed data to the recording/reproducing signal processor,
controlling the recording/reproducing signal processor to receive the processed data from the external signal processor, encode the processed data to obtain encoded data, and transmit the encoded data to the first deck which then records the encoded data on the first optical disc,
controlling the reproducing signal processor to receive the data reproduced from the other second optical disc by the second deck, decode the reproduced data to obtain decoded data, and transmit the decoded data to the external signal processor, and
controlling the external signal processor to receive the decoded data from the reproducing signal processor, process the decoded data to obtain an audio/video signal, and transmit the audio/video signal to a display device.

18. The method of claim 14, wherein the first deck is operable to record data on and reproduce data from the first optical disc; and
wherein the second deck is operable only to record data on the second optical disc.

19. The method of claim 14, wherein the external signal is a TV input signal, an A/V (audio/video) input signal, or a DV (digital video) input signal.

20. A method of controlling a dual-deck optical disc system, the dual-deck optical disc system comprising a plurality of decks operable to record data on and reproduce data from optical discs mounted in the plurality of decks, the method comprising:
receiving from a user a command to simultaneously perform a copy operation and output an external signal to a display device; and
in response to the command to simultaneously perform a copy operation and output an external signal to a display device, controlling a first deck of the plurality of decks having mounted therein a first optical disc of the optical discs and a second deck of the plurality of decks having mounted therein a second optical disc of the optical discs to perform the copy operation by copying data of the second optical disc mounted in the second deck onto the first optical disc mounted in the first deck, and simultaneously outputting the external signal to the display device.

21. The method of claim 20, further comprising:
displaying the external signal on the display device while the first deck and the second deck are performing the copy operation;
determining whether an error has occurred in the copy operation and whether the copy operation has been completed while the external signal is simultaneously being output to and displayed on the display device; and
displaying a message on the display device on which the external signal is being displayed to notify the user when an error has occurred in the copy operation or when the copy operation has been completed.

22. The method of claim 20, wherein the dual-deck optical disc system further comprises:
a recording/reproducing signal processor;
a reproducing signal processor; and
an external signal processor;
wherein the copy operation is a normal-speed copy operation that requires substantially a same amount of time as is required to reproduce data being copied at a normal speed at which the data being copied is intended to be viewed and/or listened to; and
wherein the method further comprises, in response to the command to simultaneously perform the copy operation and output the external signal to the display device:
controlling the reproducing signal processor to receive data reproduced from the second optical disc by the second deck, decode the reproduced data to obtain decoded data, and transmit the decoded data to the recording/reproducing signal processor;
controlling the recording/reproducing signal processor to receive the decoded data from the reproducing signal processor, encode the decoded data to obtain encoded data, and transmit the encoded data to the first one deck which then copies the encoded data onto the first optical disc; and
controlling the external signal processor to receive the external signal, process the external signal to obtain video and audio signals, and transmit the video and audio signals to the display device.

23. The dual-deck optical deck system of claim 20, wherein the dual-deck optical disc system further comprises:
a recording/reproducing signal processor;
a reproducing signal processor; and
an external signal processor;
wherein the copy operation is a high-speed copy operation that requires no more than half as much time as is required to reproduce data being copied at a normal speed at which the data being copied is intended to be viewed and/or listened to; and
wherein the method further comprises, in response to the command to simultaneously perform the copy operation and output the external signal to the display device:
controlling the reproducing signal processor to receive data reproduced from the second optical disc by the second deck and, without decoding the reproduced data, transmit the reproduced data to the recording/reproducing signal processor;
controlling the recording/reproducing signal processor to receive the reproduced data from the reproducing signal processor and, without encoding the reproduced data, transmit the reproduced data to the first deck which then copies the reproduced data onto the first optical disc; and
controlling the external signal processor to receive the external signal, process the external signal to obtain video and audio signals, and transmit the video and audio signals to the display device.

24. The method of claim 20, wherein the first deck is operable to record data on and reproduce data from the first optical disc; and
wherein the second deck is operable only to record data on the second optical disc.

25. The dual-deck optical system of claim 20, wherein the external signal is a TV input signal, an A/V (audio/video) input signal, or a DV (digital video) input signal.
